(19) United States
(12) Patent Application Publication
(10) Pub. No.: US 2017/0141684 A1
(43) Pub. Date: May 18, 2017

(54) Method and System for DC-DC Voltage Converters

(71) Applicant: Intersil Americas LLC, Milpitas, CA (US)

(72) Inventor: David L. Beck, Austin, TX (US)

(21) Appl. No.: 15/133,487

(22) Filed: Apr. 20, 2016

Related U.S. Application Data
(60) Provisional application No. 62/256,898, filed on Nov. 18, 2015.

(51) Int. Cl. H02M 3/158; H02M 1/08

(52) U.S. Cl. CPC H02M 3/158; H02M 1/08; H02M 2001/0009

(57) ABSTRACT

On embodiment pertains to an apparatus including a current share control circuit configured to receive a first sample inductor current sense signal representative of a current in a first power stage, configured to receive from a data bus a second sample inductor current sense signal from a fixed reference phase, and which generates a trim signal. A first control loop having an output configured to be coupled to an input of the first power stage, and configured to receive a signal representative of an output voltage and the trim signal.

### CROSS-REFERENCED TO RELATED APPLICATION

This application claims the benefit of provisional U.S. Patent Application Ser. No. 62/256,898 filed Nov. 18, 2015, which is incorporated herein by reference in its entirety.

### BRIEF DESCRIPTION OF THE DRAWINGS

FIG. 1 illustrates an embodiment of an electrical system;

FIG. 2a illustrates an embodiment of a multiphase digital DC-DC voltage converter;

FIG. 2b illustrates an embodiment of a digital control loop for a voltage mode DC-DC voltage converter;

FIG. 2c illustrates an embodiment of a digital control loop for a current mode DC-DC voltage converter;

FIG. 2d illustrates an embodiment of a digital current share control circuit;

FIG. 2e illustrates an embodiment of a power stage;

FIG. 3 illustrates an embodiment of a data packet in the digital current share bus; and

FIG. 4 illustrates one embodiment of operation of the multiphase digital DC-DC converter.

It should be noted that some details of the Figures have been simplified and are drawn to facilitate understanding of the inventive embodiments rather than to maintain strict structural accuracy, detail, and scale. It should also be noted that not all circuit elements and operating steps are illustrated, as the general methods of circuit design and operation are well known. It should also be noted that not all details about voltage converters are illustrated, as general designs of voltage converters are well known.

Reference will now be made in detail to the present embodiments (exemplary embodiments) of the present teachings, examples of which are illustrated in the accompanying drawings. Wherever possible, the same reference numbers will be used throughout the drawings to refer to the same or like parts.

### DESCRIPTION OF THE EMBODIMENTS

Embodiments relate generally to multiphase DC-DC voltage converters having a fixed reference phase.

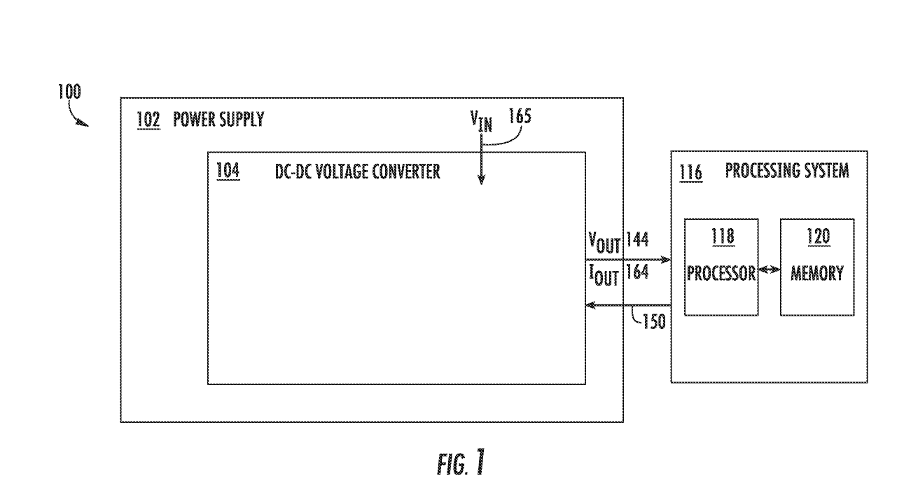

FIG. 1 illustrates an exemplary electrical system 100 comprising a load, e.g. a processing system 116, and power supply 102 that includes a voltage converter, e.g. a DC-DC voltage converter 104. The processor 118 can be electrically coupled to, communicate with, and/or control the voltage converter through a voltage converter data bus 150. This electrical system 100 may be a device related to telecommunications, automobiles, semiconductor test and manufacturing equipment, consumer electronics, or any type of electronic equipment.

The power supply 102 may be AC to DC power supply, or a DC supply powered by a battery. The power supply 102 provides a DC-DC voltage converter 104 with an input voltage 165, V_{IN}, to power the DC-DC voltage converter 104. The DC-DC voltage converter 104 has an output voltage 144, V_{OUT}, and a converter output current 164, I_{OUT}. The output voltage 144 is a voltage that is regulated in a manner further described below, and is provided at an output of the DC-DC voltage converter 104.

In one embodiment, the processing system 116 may include a processor 118 and memory 120 which are coupled to one another. In another embodiment, the processor 118 may be one or more microprocessors, microcontrollers, embedded processors, digital signal processors, or a combination of two or more of the foregoing. The memory 120 may be one or more volatile memories and/or non-volatile memories such as static random access memory, dynamic random access memory, read only memory, flash memory, or a combination of two or more of the foregoing. The DC-DC voltage converter 104 provides a voltage to the load, e.g. the processing system 116, which is more precise and/or more efficient than a voltage provided by other voltage sources such as low drop out regulators.

The DC-DC voltage converter 104 illustrated in FIG. 1 can be implemented as a current mode or a voltage mode DC-DC voltage converter. Voltage mode DC-DC voltage converters are often used to avoid having to implement circuitry to measure instantaneous current levels. The multiphase DC-DC voltage converter subsequently illustrated is a voltage mode DC-DC voltage converter. However, the present invention may be used in a current mode DC-DC voltage converters. An example of a control loop for a current mode DC-DC voltage converter is also subsequently exemplified.

Multiphase DC-DC voltage converters are used to provide higher and more accurate output current capacity. Digital DC-DC voltage converters are used to provide higher efficiency and operating flexibility.

The DC-DC voltage converter 104 of FIG. 1 is advantageously formed with a multiphase digital DC-DC voltage converter having fixed reference phase. The term ‘fixed’ means that the reference phase does not change from one phase to another; this will be further described subsequently. Further, term ‘fixed’ also means that the output voltage of the DC-DC voltage converter 104 has a fixed, or substantially constant, output voltage. The output voltage of the DC-DC voltage converter 104 (and of each of its constituent phases) do not change in response to variations in the output current of the DC-DC voltage converter 104 (and its constituent phases). Other multiphase DC-DC voltage converters can be implemented with the reference phase moving amongst two or more phases during the converter operation, and/or requiring a load line impedance such that the output voltage varies with output current.

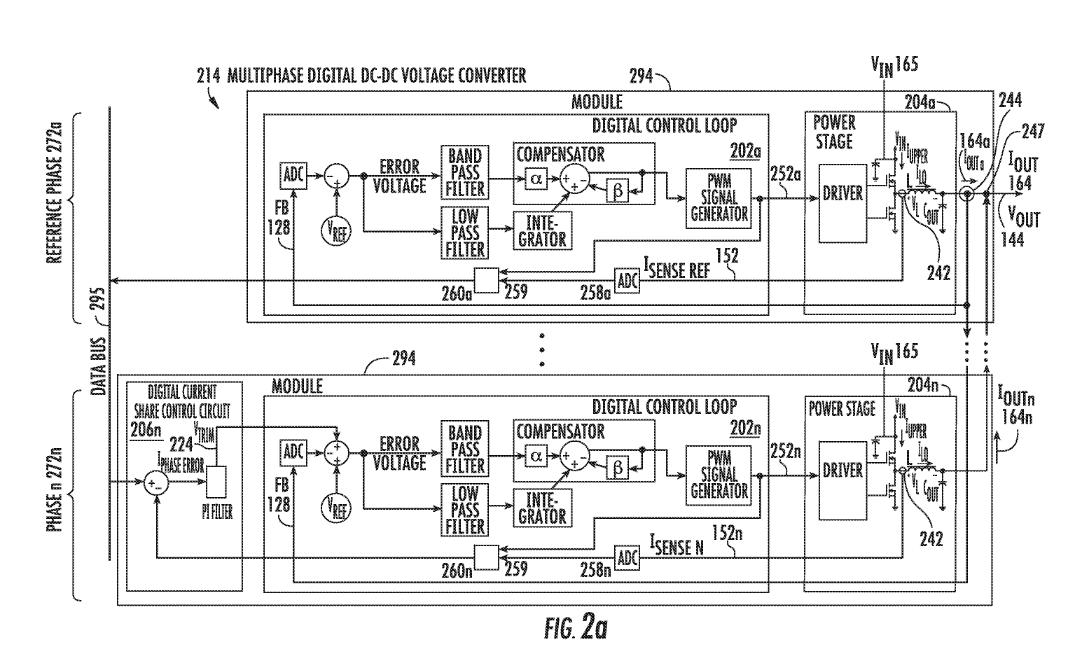

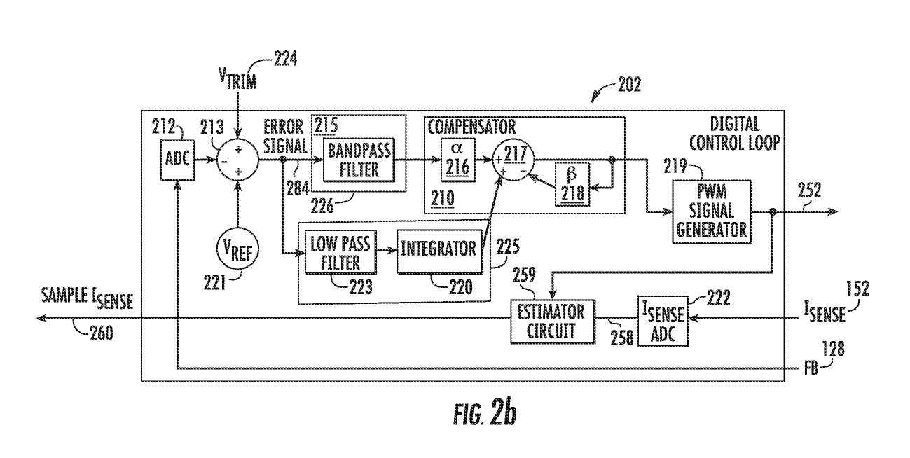

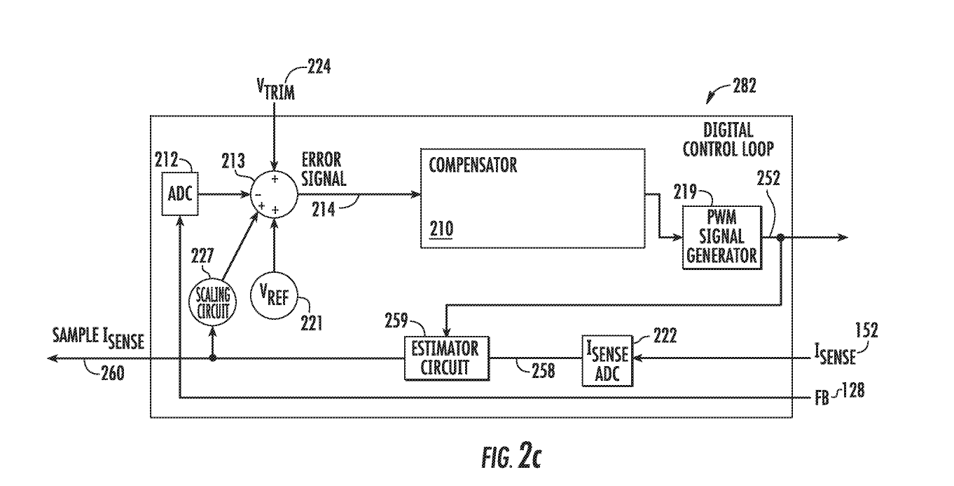

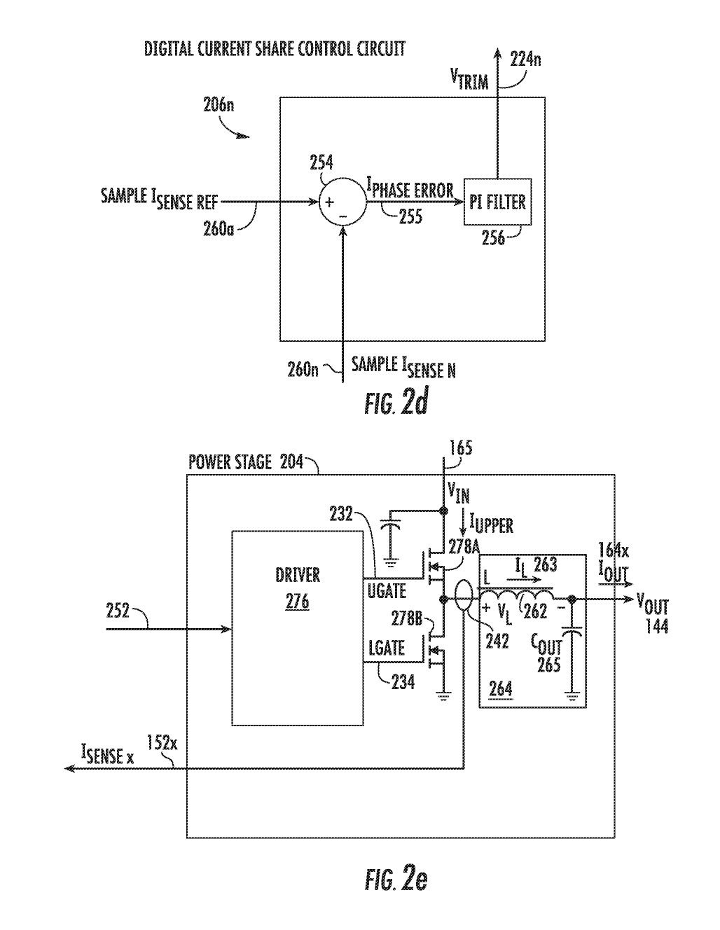

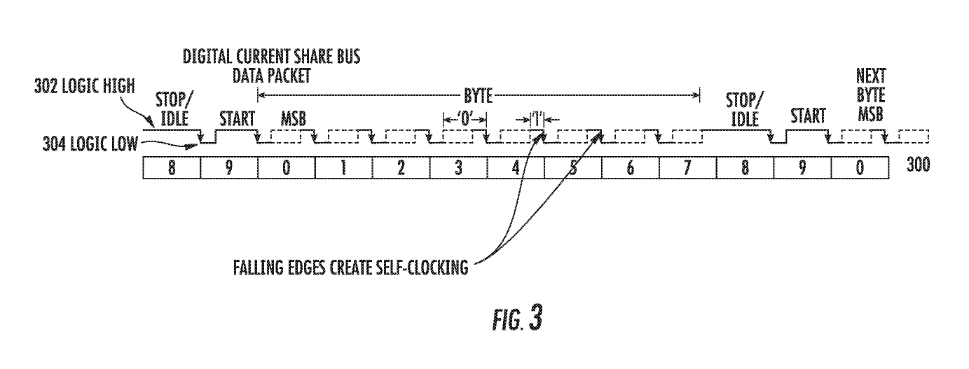

The fixed reference phase is chosen by a designer or user of the power supply 102, and may be any of the n phases. The other phases' output currents are adjusted by using a current signal of the fixed reference phase. Embodiments of a multiphase digital DC-DC voltage converter having a fixed reference phase are subsequently described in more detail with respect to FIGS. 2a through 4.

One embodiment of a multiphase digital DC-DC voltage converter 214 with a fixed reference phase 272a is illustrated in FIG. 2a. This multiphase digital DC-DC voltage converter 214 is a voltage mode DC-DC voltage converter. The following is a summary description of the exemplary embodiment. More implementation and operation details will be later described.

The illustrated multiphase digital DC-DC voltage converter 214 has n phases. FIG. 2a illustrates two phases: a fixed reference phase 272a, and phase n 272n. Both phases include control loops. For each phase 272 to generate the desired output current, and the multiphase digital DC-DC voltage converter 214 to generate the desired output voltage, the phases 272a, 272n must be coupled, e.g., in the manner described below.

The outputs of each phase 272 are coupled together so that each phase 272 has an output voltage 144, V_{OUT}, which is equal (or substantially equal). The output currents, e.g. I_{OUT} a 164a and I_{OUT n} 164n, of each phase 272 are combined to provide a converter output current 164, I_{OUT}. Each phase of the multiphase digital DC-DC voltage converter 214 includes a digital control loop 202, and a power stage 204.

In another embodiment the control loop may be an analog control loop. In such a case the subsequently described current share control could be implemented in analog or digital design but would require, e.g., a digital to analog converter to convert respectively the digital input or output to an analog input or output. However, the subsequently described embodiments illustrate digital multiphase DC-DC voltage converters.

In one embodiment, the digital control loop 202 and power stage 204 may be implemented in a power module 294. In another embodiment, the non-reference phases include a digital current share control circuit 206, described hereafter. In another embodiment, the digital control loop 202, power stage 204, and digital current share control circuit 206 may be implemented in a power module 294.

Each power stage 204 is provided with an input voltage, V_{IN}, 165, which in one embodiment is the same for each power stage 204. In one embodiment, each power stage 204 generates an analog inductor current sense signal 152, I_{SENSE}, e.g., a voltage signal representative of the inductor current, or an upper power transistor current by sensing such current with a current sensor 242. Alternatively, the inductor current sense signal 152 may be synthesized based upon an emulation of the inductor current or transistor current, e.g. in the digital control loop 202 or the power stage 204. Such synthesis is further described in U.S. Pat. No. RE43414 issued on May 29, 2012, which is hereby incorporated by reference. In a further embodiment, the inductor current sense signal 152 is digitized, e.g. in the digital control loop 202 or power stage 204.

In one embodiment, a voltage sensor 244 is coupled to the output of the multiphase digital DC-DC voltage converter 214. The voltage sensor 244 generates an output voltage sense signal 128, FB, representative of the output voltage 144. The output voltage sense signal 128 may communicate information about the output voltage 144 by varying its voltage or current level. In another embodiment, the output voltage sense signal 128 is digitized, e.g. in the power stage 204 or the digital control loop 202. In another embodiment, the voltage outputs of all of the phases 272 are connected at the DC-DC voltage converter output 247. The DC-DC voltage converter output 247 is configured to provide the output voltage 144 of the multiphase digital DC-DC voltage converter 214.

An input of the power stage 204 is configured to receive a pulse width modulator (‘PWM’) signal 252 from the output of the digital control loop 202. As will be described subsequently, the PWM signal 252 is used to alternatively turn on and off upper and lower power transistors in the power stage 204.

All phases, but the fixed reference phase 272a, include a digital current share control circuit 206. The input of the digital current share control circuit 206 of a given phase is configured to receive a signal corresponding to the digitized inductor current sense signal 258a, of the fixed reference phase 272a, through the data bus 295, and a signal corresponding to the digitized inductor current sense signal for the given phase.

Because of the finite latency of the data bus 295, it is may not be practical to convey over the data bus 295 more than one item of data corresponding to the inductor current during a single cycle of the PWM signal 252 over the data bus 295. In one embodiment, to reduce the latency of the digital control loop 202, an estimator circuit 259, implemented with, e.g., an interpolating filter, may be used to determine the average, peak or valley level of the inductor current sense signal 152 during a single cycle of the PWM signal 252 (sample inductor current sense signal′ 260). In one embodiment, the sample inductor current sense signal 260 may be derived from samples of the inductor current sense signal 152 measured during the single cycle. The estimator circuit 259 is coupled to the PWM signal 252. In one embodiment, the PWM signal 252 uses dual edge modulation so that both edges of the PWM pulse can be adjusted. Further, the PWM signal 252 has a fixed frequency. As a result, (a) the average amplitude of the inductor current sense signal occurs at the middle of the PWM pulse or the middle of the PWM pulse period, (b) the peak amplitude of the inductor current sense signal 152 occurs at the trailing edge of the PWM pulse, and (c) the valley amplitude of the inductor current occurs at the leading edge of the PWM pulse. The same type of sample inductor current sense signal 260, e.g. average, peak, or valley, would be used in all of the phases 272. The data bus 295 is configured to receive the sample inductor current sense signal 260a of the reference phase 272a. The sample inductor current sense signals 260 of the other phases are conveyed to their respective digital current share control circuits 206. This technique has the further benefit of permitting the use of a lower sampling rate analog to digital converter (‘ADC’) to digitize the inductor current sense signal 152.

The digital current share control circuit 206 generates a trim voltage 224 which corresponds to the difference between such currents and is used to adjust the waveform of the PWM signal 252 for the given phase.

As described further below, the fixed reference phase's inductor current sense signal 152a, I_{SENSE REF}, is digitized, and a sample inductor current sense signal 260a is created and transmitted over a data bus 295 to other phases, e.g. Phase 272n. Each of the other phases compare the sample inductor current sense signal 260a of the reference phase with the sample inductor current sense signal 260 of that phase to adjust their respective output current of that phase.

Because the multiphase digital DC-DC voltage converter 214 uses a fixed reference phase 272a, the data bus 295, in one embodiment, can be implemented with a digital push pull bus. A push pull bus has higher bandwidth then alternative bus designs requiring the use of pull up resistors which may be required to implement multiphase digital DC-DC voltage converters that do not have a fixed reference phase and thus requires arbitration. The data bus 295 implemented with a push pull topology has higher noise immunity, and permits the user to operate the multiphase digital DC-DC voltage converter 214 at higher data rates. In another embodiment, the data bus 295 can be implement with a one wire bus. Thus, if each phase is implemented as a single unit, e.g. single integrated circuit or module, then it need only have one pin to connect to the data bus 295. The data bus 295 is coupled to digital current share control circuit(s) 206 which will be subsequently described. The digital current share control circuit(s) 206 are coupled to digital control loop(s) 202 (subsequently described) in corresponding phases 272.

FIG. 2b illustrates an exemplary digital control loop 202 for a multiphase digital DC-DC voltage converter 214 that operates in voltage control mode. The digital control loop 202 is configured to receive the output voltage sense signal 128. In one embodiment, all digital control loops 202, except for the digital control loop 202 of the fixed reference phase 272a, are also configured to receive a trim voltage 224 from a digital current share control circuit 206 which is part of the same phase 272. The digital control loop 202 includes an ADC 212 that digitizes the output voltage sense signal 128. In one embodiment, a control loop digital subtractor 213 subtracts the voltage level of the digitized output voltage sense signal from a reference voltage 221, e.g. a digitized reference voltage; the reference voltage 221 is defined by the designer or user of the power supply 102. In one embodiment, the control loop digital subtractor 213 has a gain. In an analog control loop, the control loop digital subtractor 213 would be an error amplifier. The reference voltage 221 is indicative of the desired output voltage 144. The control loop digital subtractor 213 generates an error signal 284, e.g. a voltage. In one embodiment, the control loop digital subtractor 213 can perform addition and subtraction functions. For the phases that are not the fixed reference phase 272a, in one embodiment, the error signal 284 is calculated by adding the trim voltage 224, the reference voltage, and the negative value of the voltage level of the digitized output voltage sense signal. This calculation may be performed in a number of ways. In one embodiment, the error signal 284 is calculated by adding the trim voltage 224 to the difference between the reference voltage 221 and the voltage level of the digitized output voltage sense signal. In another embodiment, the error signal 284 is calculated by adding the reference voltage 221 to the difference between the trim voltage 224 and the voltage level of the digitized output voltage sense signal. In another embodiment the voltage level of the digitized output voltage sense signal can be subtracted from the sum of the reference voltage 221 and the trim voltage 224. For the fixed reference phase 272a, the voltage level of the error signal 284 is the difference between the reference voltage 221 and the voltage level of the digitized output voltage sense signal.

The remainder of the digital control loop 202 will now be described. A DC branch 225 and an AC branch 226 are configured to receive the error signal 284. The DC branch 225 generates a signal representative of the DC component of the error signal 284. A compensator 210, e.g. a single cycle response digital compensator, is configured to receive the output of the DC branch 225. The compensator 210 is used to compensate the multiphase digital DC-DC voltage converter 214 to recover from transient output voltage deviations. In one embodiment, the DC branch 225 is implemented by a low pass filter 223 having an output coupled to an integrator 220. For this embodiment, the input of the low pass filter 223 is configured to receive the error signal 284.

The AC branch 226 generates a signal representative of the AC component of the error signal 284. In one embodiment, the AC branch 226 includes by a bandpass filter 215, e.g. a ripple filter, which is configured to receive the error signal 284. The AC branch 226 removes the peak to peak ripple signal component and harmonics of the switching frequency.

A compensator 210, e.g. a single cycle response digital compensator, is configured to receive the output of the AC branch 226, e.g. the output of the bandpass filter 215, and the DC branch 225, e.g. the output of the integrator 220. A single cycle response digital compensator for use in digital power management systems is further described in U.S. Pat. No. 8,575,910, which is hereby incorporated by reference.

One embodiment of a compensator 210 is shown in FIG. 2b. The illustrated compensator 210 includes an alpha gain circuit 216 and is configured to receive the output of the AC branch 226, e.g. the output of the bandpass filter 215, and multiply that signal by a gain of alpha (α). The alpha gain circuit 216 improves the bandwidth of the AC branch 226. The compensator 210 also includes a beta gain circuit 218 which is configured to receive the output of a digital summer 217, and multiply that signal by a gain of beta (β). When fed back to the digital summer 217, the feedback loop formed by the beta gain circuit 218 improves the compensator's stability, and facilitates the output of the compensator 210 to reach steady state more quickly. The digital summer 217 is configured to receive the output of the alpha gain circuit 216, the output of the beta gain circuit 218, and the output of the DC branch 225, e.g. the integrator 220. The output of the digital summer 217 is the summation of the output of the alpha gain circuit 216, the negative value of the output of the beta gain circuit 218, and the output of the DC branch 225, e.g. the output of the integrator 220. This is a function performed by the digital summer 217, thus a summer may be capable of mathematical manipulations, such as subtraction; in addition to addition. This function may be implemented in numerous ways. The output of the beta gain circuit 218 may be subtracted from the summation of the outputs of the alpha gain circuit 216 and the DC branch 225. Alternatively, the output of the alpha gain circuit 216 can be added to the difference of the outputs of the DC branch 225 and the beta gain circuit 218. In another embodiment, the output of the DC branch 225 can be added to the difference of the outputs of the alpha gain circuit 216 and the beta gain circuit 218.

In one embodiment, alpha and beta may be defined by the designer or user of the power supply 102. In another embodiment, the gain of alpha gain circuit 216 may range from 50 to 200, and the gain of beta gain circuit 218 may range from 0 to 1. In yet another embodiment, the gain of beta gain circuit 218 is 0.7.

A PWM signal generator 219 is configured to receive the output of the compensator 210, e.g. the output of the digital summer 217. In one embodiment, the PWM signal generator 219 compares, e.g. digitally, the output of the compensator with a digitized saw tooth waveform. The output of the PWM signal generator 219 is configured to provide a PWM signal 252. The PWM signal 252 has pulses of varying widths depending upon the output of the compensator 210.

In one embodiment, the digital control loop 202 is configured to receive the inductor current sense signal 152 from the corresponding power stage 204. An inductor current sense signal, or I_{SENSE}, ADC 222 digitizes the inductor current sense signal 152. An estimator circuit 259 is configured to receive the digitized inductor current sense signal 258 and the PWM signal 252. As described above, the estimator circuit 259 generates a sample inductor current sense signal 260, e.g. representative of the average inductor current.

FIG. 2c illustrates an exemplary digital control loop 282 for a current mode multiphase digital DC-DC voltage converter. In this embodiment, the sample inductor current sense signal 260 is utilized in the digital control loop 282 of the current mode multiphase digital DC-DC voltage converter. A scaling circuit 227 is configured to receive the sample inductor current sense signal 260. The scaling circuit 227 adjusts the level, e.g. the voltage, of the sample inductor current sense signal 260. The control loop digital subtractor 213 is configured to receive the output of the scaling circuit 227. In one embodiment, the output of the scaling circuit 227 is added to the sum of the reference voltage 221 and trim voltage 224 less the voltage level corresponding to the output voltage sense signal 128.

Now, the digital current share control circuit 206 will be described. An exemplary digital current share control circuit 206n, which provides the trim voltage 224 to a compensator 210, is illustrated in FIG. 2d. The exemplary digital current share control circuit 206 includes a control circuit digital summer 254 and a digital proportional integral (PI) filter 256. The control circuit digital summer 254 is configured to receive the sample inductor current sense signal 260a provided by the fixed reference phase 272a through the data bus 295, and sample inductor current sense signal 260n of the phase 272n of which the digital current share control circuit 206n is part. The control circuit digital summer 254 compares the sample inductor current sense signal 260a and the sample inductor current sense signal 260n, e.g., subtracts the sample inductor current sense signal 260a from the sample inductor current sense signal 260n or vice versa. The output of the control circuit digital summer 254 is the phase current error signal 255, I_{PHASE ERROR}. The PI filter 256 is configured to receive the phase current error signal 255. The output of the PI filter 256 is the trim voltage 224n which is configured to be coupled to the digital control loop 202n.

FIG. 2e illustrates one embodiment of a power stage 204. The power stage 204 includes a driver 276, power transistors, e.g. upper metal oxide semiconductor field effect transistor (‘MOSFET’) 278A and a lower MOSFET 278B, and an output filter 264. The driver 276 is configured to receive the PWM signal 252 from the digital control loop 202. The driver 276 generates a UGate control signal 232 and an LGate control signal 234 that are respectively coupled to inputs of the upper MOSFET 278A and the lower MOSFET 278B. UGate control signal 232 and an LGate control signal 234 respectively cause the upper MOSFET 278A and the lower MOSFET 278B to alternatively switch on and off. In one embodiment, the driver 276 may include dead time control and bootstrapping. The output filter 264 is coupled to the source of the upper MOSFET 278A, and the drain of the lower MOSFET 278B. In one embodiment, the output filter 264 includes a series inductor 262 and shunt capacitor 265. The output of the power stage 204 has a corresponding output voltage 144, V_{OUT}, and output current, I_{OUT}, 164x. The output voltage 144 at the output of the power stage 204 is regulated as described herein.

In one embodiment, a current sensor 242 is coupled to a terminal of the series inductor 262 of the output filter 264. The current sensor 242 generates an inductor current sense signal 152, I_{SENSE}, representative of the inductor current 263, I_{L}. The inductor current sense signal 152x may communicate information about the inductor current 263 by varying its voltage or current level.

In another embodiment, a current sensor may be placed proximate to the upper MOSFET 278A to measure the drain to source current of the upper MOSFET 278A. A sense signal representative of the upper MOSFET 278A drain to source current may be used in lieu of the inductor current sense signal 152x in the embodiments described herein. In yet a further embodiment, the inductor current sense signal 152 may be created by synthesizing (e.g. emulating) the inductor current 263 (further described herein), or the transistor current, e.g. drain to source current.

In one embodiment, the current sensor 242 and corresponding inductor current sense signal 152 are coupled to the digital control loop 202. For the fixed reference phase 272a, the inductor current sense signal 152a is also coupled to the data bus 295. For the other phases 272b-n, the corresponding inductor current sense signals 152b-n are coupled to corresponding digital current share control circuits 206b-n. In another embodiment, the inductor current sense signal 152 has a triangular or saw tooth waveform. In an alternative embodiment, the inductor current sense signal 152 may be synthesized, rather than sensed by emulating the inductor current 263.

In one embodiment, the upper MOSFET 278A and the lower MOSFET 278B are powered by the power supply 102. In another embodiment, the power supply 102 provides an input voltage 165, V_{IN}, which is coupled to the drain of the upper MOSFET 278A. In yet a further embodiment, the input voltage 165 is a direct current (‘DC’) voltage provided by the power supply 102.

In one embodiment, the digital control loop 202, digital current share control circuit 206 (if required), driver 276 and at least one power transistor are fabricated on a single integrated circuit (‘IC’). Alternatively, the digital control loop 202, digital current share control circuit 206 (if required), and driver 276 may be fabricated on a single IC that does not include any power transistors. In another embodiment, the digital control loop 202 and the digital current share control circuit 206 (if required) may be fabricated on a single IC; the driver 276 and at least one power transistor may be fabricated on one or more separate ICs. In a further embodiment, the upper MOSFET 278A and the lower MOSFET 278B may be fabricated on a single IC.

Because a fixed reference phase 272a is used, the implementation and operation of the multiphase digital DC-DC voltage converter 214 is simplified. For example the data bus 295 is simplified, needing only to convey the samples of the digitized inductor current sense signal 258a of the fixed reference phase 272a to the other phases. In one embodiment, the data bus 295 may be implemented as a push pull bus rather than a pull up bus, and thus have a very high bandwidth. The designer of the power supply 102 can utilize the high bandwidth to trade off signal to noise ratio and speed. An example of such a data bus is illustrated in U.S. Pat. No. 8,239,597 which is hereby incorporated by reference. The digitized I_{SENSE REF} signal 258a of the fixed reference phase 272a can be applied to the data bus 295 with a digital logic high 302 and logic low 304 pulse waveform 300 as illustrated in FIG. 3. FIG. 3 illustrates one embodiment of a simplified data structure having ten bits for each sample including a start and stop bit, and eight bits of data. In another embodiment, the bus signal can be self clocking, e.g. self clocking on falling edges of each bit.

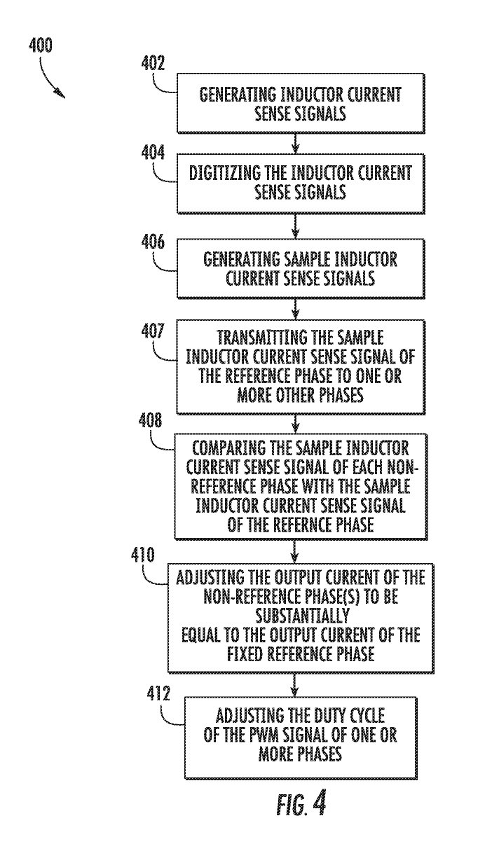

One embodiment of a method of operation 400 of the multiphase digital DC-DC voltage converter 214 set forth above will now be described, as further illustrated in FIG. 4. In block 402, a fixed reference phase 272a and at least one phase other than the fixed reference phase each generate inductor current sense signals 152. In block 404, analog inductor current sense signals 152 are digitized becoming a digitized inductor current sense signals 258. In block 406, sample inductor current sense signals 260 are generated, e.g. by the estimator circuit 259, from the corresponding digitized inductor current sense signals 258. In one embodiment, the sample inductor current sense signals 260a-n represent one of average inductor current, peak inductor current, and valley inductor current. In block 407, the sample inductor current sense signal 260a of the reference phase 272a is communicated, e.g. transmitted, to one or more other phases (i.e. the non-reference phase(s)). In one embodiment, the sample inductor current sense signal 260a is communicated, to one or more other phases over a data bus 295 such as a digital push pull bus. In block 408, the sample inductor current sense signal of the at least one other phase is compared with the sample inductor current sense signal 260a of the fixed reference phase 272a. In one embodiment, such comparison entails subtracting the digitized inductor current sense signal 258a of the fixed reference phase 272a from the sample output current sense signal of each of the at least one other phase. In another embodiment, such subtraction is used to create a trim voltage 224. In block 410, the output current of the at least one other phase is adjusted to be substantially equal to the output current signal of the fixed reference phase. In block 412, one or more phases adjust the duty cycle of their PWM signal.

Although only a DC-DC buck converter, the invention may be implemented in other DC-DC converter topologies, including without limitation boost converters and buck-boost converters.

### EXAMPLE EMBODIMENTS

Example 1 includes an apparatus, comprising: a current share control circuit configured to receive a first sample inductor current sense signal representative of a current in a first power stage, configured to receive from a data bus a second sample inductor current sense signal from a fixed reference phase, and which generates a trim signal; a first control loop having an output configured to be coupled to an input of the first power stage, and configured to receive a signal representative of an output voltage and the trim signal.

Example 2 includes the apparatus of Example 1, wherein the first control loop is further configured to receive the first sample inductor current sense signal.

Example 3 includes the apparatus of Example 1, further comprising: the data bus;

a second power stage; and a second control loop, in the fixed reference phase, having an output coupled to an input of the second power stage.

Example 4 includes the apparatus of Example 3, wherein the second control loop is further configured to receive a second inductor current sense signal representative of a current in the second power stage.

Example 5 includes the apparatus of Example 3, further comprising: the first power stage having a first output; the second power stage having a second output; a DC-DC voltage converter output connected to the first output and the second output; wherein the DC-DC voltage converter output is configured to provide the output voltage; and a voltage sensor coupled to the DC-DC voltage converter output which is configured to provide the signal representative of the output voltage.

Example 6 includes the apparatus of Example 1, wherein the first control loop further comprises: a first reference voltage; one of a first subtractor and a first error amplifier, configured to receive the first reference voltage and the signal representative of the output voltage; and a first compensator coupled to an output of the one of the first subtractor and the first error amplifier.

Example 7 includes the apparatus of Example 6, further comprising a first PWM signal generator having an input coupled to an output of the one of a first subtractor and a first error amplifier, and an output coupled the input of the first power stage.

Example 8 includes the apparatus of Example 3, further comprising a second PWM signal generator having an input coupled to an output of one of a second subtractor and a second error amplifier, and an output coupled to the input of the second power stage.

Example 9 includes the apparatus of Example 3, wherein the second control loop further comprises: a second reference voltage; one of a second subtractor and a second error amplifier, configured to receive the second reference voltage and the signal representative of the output voltage; and a second compensator coupled to an output of the one of the second subtractor and the second error amplifier.

Example 10 includes the apparatus of Example 1, further comprising a first estimator circuit configured to receive a first inductor current sense signal representative of the current in the first power stage, and to provide the first sample inductor current sense signal.

Example 11 includes the apparatus of Example 1 wherein the first sample inductor current sense signal is one of an average current, a peak current or a valley current.

Example 12 includes the apparatus of Example 3, further comprising a second estimator circuit configured to receive a second inductor current sense signal and to provide the second sample inductor current sense signal.

Example 13 includes a DC-DC voltage converter, comprising: a fixed reference phase including a first control loop; wherein the first power stage has a first inductor and a first output; wherein the first control loop is coupled to the first power stage; a second phase including a current share control circuit, a second control loop, and a second power stage; wherein the second power stage has a second inductor and a second output; wherein the current share control circuit is coupled to the second control loop; wherein the second control loop is coupled to the second power stage; a DC-DC voltage converter output connected to the first output and the second output; a voltage sensor coupled to the DC-DC voltage converter output which is configured to provide a signal representative of an output voltage at the DC-DC voltage converter output; wherein the first control loop and the second control loop are each configured to receive the signal representative of the output voltage; a data bus is coupled to the fixed reference phase and the second phase; and wherein the current share control circuit is configured to receive a sample inductor current sense signal through the data bus.

Example 14 includes the DC-DC voltage converter of Example 13, wherein the sample inductor current sense signal is provided by the first control loop.

Example 15 includes the DC-DC voltage converter of Example 13, further comprising a load coupled to the DC-DC voltage converter output.

Example 16 includes the DC-DC voltage converter of Example 15, wherein the load is a processor coupled to a memory.

Example 17 includes a method comprising: generating sample inductor current sense signals in a fixed reference phase and at least one other phase; transmitting the sample inductor current sense signal of the fixed reference phase to the at least one other phase; comparing the sample inductor current sense signal of each of the at least one other phase to the sample inductor current sense signal of the fixed reference phase; and adjusting the output current of the at least one other phase so that the output currents of the fixed reference phase and the at least one other phase are substantially equal.

Example 18 includes the method of Example 17, further comprising generating inductor current sense signals in the fixed reference phase and the at least one other phase.

Example 19 includes the method of Example 17, further comprising digitizing the sample inductor current sense signals.

Example 20 includes the method of Example 17, wherein transmitting the sample inductor current sense signal of the fixed reference phase further comprises transmitting the sample inductor current sense signal of the fixed reference phase over a digital bus.

Example 21 includes the method of Example 17, wherein generating sample inductor current sense signals in the fixed reference phase and the at least one other phase further comprises generating sample inductor current sense signals in the fixed reference phase and the at least one other phase wherein each of the sample inductor current sense signals are one of average current, peak current or valley current.

Example 22 includes the method of Example 17, wherein comparing each of the sample inductor current sense signal of the at least one other phase to the sample inductor current sense signal of the fixed reference phase further comprises subtracting each of the sample inductor current sense signal of at least one phase from the sample inductor current sense signal of the fixed reference phase.

Example 23 includes the method of Example 17, further comprising adjusting the duty cycle of the PWM signal of one or more phases.

It will be evident to one of ordinary skill in the art that the processes and resulting apparatus previously described can be modified to form various apparatuses having different circuit implementations and methods of operation. Notwithstanding that the numerical ranges and parameters setting forth the broad scope of the present teachings are approximations, the numerical values set forth in the specific examples are reported as precisely as possible. Signal levels and generators herein are exemplified with reference to voltage or current. However, those skilled in the art understand that a voltage signal or a voltage generator can respectively be implemented with current signals and current generators, or vice versa. Therefore, such signals may also be referred herein as signals or thresholds rather than voltages and current. Correspondingly, voltage and current generators may be referred to as generators.

Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material.

The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the methods and structures disclosed herein. It is intended that the specification and examples be considered as exemplary only, with a true scope and spirit of the present teachings being indicated by the following claims.

What is claimed is:

1. An apparatus, comprising:
a current share control circuit configured to receive a first sample inductor current sense signal representative of a current in a first power stage, configured to receive from a data bus a second sample inductor current sense signal from a fixed reference phase, and which generates a trim signal;
a first control loop having an output configured to be coupled to an input of the first power stage, and configured to receive a signal representative of an output voltage and the trim signal.

2. The apparatus of claim 1, wherein the first control loop is further configured to receive the first sample inductor current sense signal.

3. The apparatus of claim 1, further comprising:
the data bus;
a second power stage; and
a second control loop, in the fixed reference phase, having an output coupled to an input of the second power stage.

4. The apparatus of claim 3, wherein the second control loop is further configured to receive a second inductor current sense signal representative of a current in the second power stage.

5. The apparatus of claim 3, further comprising:
the first power stage having a first output;
the second power stage having a second output;
a DC-DC voltage converter output connected to the first output and the second output;
wherein the DC-DC voltage converter output is configured to provide the output voltage; and
a voltage sensor coupled to the DC-DC voltage converter output which is configured to provide the signal representative of the output voltage.

6. The apparatus of claim 1, wherein the first control loop further comprises:
a first reference voltage;
one of a first subtractor and a first error amplifier, configured to receive the first reference voltage and the signal representative of the output voltage; and
a first compensator coupled to an output of the one of the first subtractor and the first error amplifier.

7. The apparatus of claim 6, further comprising a first PWM signal generator having an input coupled to an output of the one of a first subtractor and a first error amplifier, and an output coupled the input of the first power stage.

8. The apparatus of claim 3, further comprising a second PWM signal generator having an input coupled to an output of one of a second subtractor and a second error amplifier, and an output coupled to the input of the second power stage.

9. The apparatus of claim 3, wherein the second control loop further comprises:
a second reference voltage;
one of a second subtractor and a second error amplifier, configured to receive the second reference voltage and the signal representative of the output voltage; and
a second compensator coupled to an output of the one of the second subtractor and the second error amplifier.

10. The apparatus of claim 1, further comprising a first estimator circuit configured to receive a first inductor current sense signal representative of the current in the first power stage, and to provide the first sample inductor current sense signal.

11. The apparatus of claim 1 wherein the first sample inductor current sense signal is one of an average current, a peak current or a valley current.

12. The apparatus of claim 3, further comprising a second estimator circuit configured to receive a second inductor current sense signal and to provide the second sample inductor current sense signal.

13. A DC-DC voltage converter, comprising:
a fixed reference phase including a first control loop;
a first power stage coupled to the first control loop;
wherein the first power stage has a first inductor and a first output;
a second phase including a current share control circuit, a second control loop, and a second power stage;
wherein the second power stage has a second inductor and a second output;
wherein the current share control circuit is coupled to the second control loop;
wherein the second control loop is coupled to the second power stage;
a DC-DC voltage converter output connected to the first output and the second output;
a voltage sensor coupled to the DC-DC voltage converter output which is configured to provide a signal representative of an output voltage at the DC-DC voltage converter output;
wherein the first control loop and the second control loop are each configured to receive the signal representative of the output voltage;
a data bus is coupled to the fixed reference phase and the second phase; and
wherein the current share control circuit is configured to receive a sample inductor current sense signal through the data bus.

14. The DC-DC voltage converter of claim 13, wherein the sample inductor current sense signal is provided by the first control loop.

15. The DC-DC voltage converter of claim 13, further comprising a load coupled to the DC-DC voltage converter output.

16. The DC-DC voltage converter of claim 15, wherein the load is a processor coupled to a memory.

17. A method comprising:
generating sample inductor current sense signals in a fixed reference phase and at least one other phase;
transmitting the sample inductor current sense signal of the fixed reference phase to the at least one other phase;
comparing the sample inductor current sense signal of each of the at least one other phase to the sample inductor current sense signal of the fixed reference phase; and
adjusting an output current of the at least one other phase so that the output currents of the fixed reference phase and the at least one other phase are substantially equal.

18. The method of claim 17, further comprising generating inductor current sense signals in the fixed reference phase and the at least one other phase.

19. The method of claim 17, further comprising digitizing the sample inductor current sense signals.

20. The method of claim 17, wherein transmitting the sample inductor current sense signal of the fixed reference phase further comprises transmitting the sample inductor current sense signal of the fixed reference phase over a digital bus.

21. The method of claim 17, wherein generating sample inductor current sense signals in the fixed reference phase and the at least one other phase further comprises generating sample inductor current sense signals in the fixed reference phase and the at least one other phase wherein each of the sample inductor current sense signals are one of average current, peak current or valley current.

22. The method of claim 17, wherein comparing each of the sample inductor current sense signal of the at least one other phase to the sample inductor current sense signal of the fixed reference phase further comprises subtracting each of the sample inductor current sense signal of at least one phase from the sample inductor current sense signal of the fixed reference phase.

23. The method of claim 17, further comprising adjusting the duty cycle of the PWM signal of one or more phases.
